(19) United States
(12) Patent Application Publication
(10) Pub. No.: US 2010/0326779 A1
(43) Pub. Date: Dec. 30, 2010

(54) Fluidic Dampening Device

(76) Inventor: Ralph S. Norman, San Diego, CA (US)

Correspondence Address: Thompson E. Fehr;Suite 300, Goldenwest Corporate Center, 5025 Adams Avenue, Ogden, UT, 84403, US

(21) Appl. No.: 12/877,606

(22) Filed: Sep. 8, 2010

Related U.S. Application Data
(63) Continuation of application No. 10/801,626, filed on Mar. 15, 2004, now abandoned.

(51) Int. Cl. B62K 21/08; F16F 9/14

(52) U.S. Cl. 188/306

(57) ABSTRACT

An improved fluidic dampening device having a first clamp attached to the housing of a fluidic dampening device near the left side of such housing and a second clamp attached to such housing near the right side of the housing to create apertures for accommodating handlebars. Each upper segment is releasably connected to each respective lower segment, although a first end of each upper segment may be rotatably connected to each respective lower segment while a second end is releasably connected. The housing is preferably so attached to the first clamp and to the second clamp that the uppermost portion of the housing is lower the lowermost portion of the apertures. Preferably, the lower segments are attached to the top of a triple clamp; but neither the attachment of the first clamp to the housing nor the attachment of the second clamp to the housing involves the triple clamp.

### CROSS-REFERENCE TO RELATED APPLICATION

This is a continuation of co-pending U.S. application Ser. No. 10/801,626, filed on Mar. 15, 2004.

### BACKGROUND OF THE INVENTION

1. Field of the Invention

This invention relates to a device that uses a fluid to dampen a force that tends to move the plane of rotation of a steerable wheel or wheels of a vehicle having a shaft used to steer such wheel or wheels away from being generally parallel to the frame of such vehicle. It also relates to any steering device, such as a ski of a snowmobile or the exhaust jet of a personal watercraft, that uses a shaft or the like in the steering process.

2. Description of the Related Art

Dampening devices of the type subject to the present invention are those which contain a rotatable wiper in a housing having a channel running from the a portion of the housing on a first side of the wiper to a portion of the housing on a second side of the wiper so that when the housing is filled with fluid, as the wiper is moved, it forces fluid through the channel.

Examples of such devices are those of U.S. Pat. No. 4,773,514 and United States patent application Ser. No. 10/166,498.

Although a dissimilar type of dampener seems to be shown in U.S. Pat. No. 5,516,133 as being below a portion of the handlebars of a bicycle, the present inventor is unaware of any dampener of the type with the rotatable wiper and housing with a channel that is mounted below the handlebars except for the dampener of U.S. Pat. No. 6,802,519. The dampener of U.S. Pat. No. 6,802,519 is, however, formed within the triple clamp and can only be argued to be attached to a first clamp through the triple clam, itself. And U.S. Pat. No. 6,145,637 has no clamps that create apertures to accommodate handlebars.

### BRIEF SUMMARY OF THE INVENTION

The present Improved Fluidic Dampening Device has a first clamp attached to a housing containing a wiper and a channel for transferring fluid from a first side of the wiper to a second side of the wiper near a first side of the housing as well as a second clamp attached to the housing near a second side of the housing.

Each clamp has an upper section which is releasably fastenable to the handlebars of a vehicle. Thus, the housing is suspended below the handlebars, decreasing the likelihood of the face of a rider striking the housing when the vehicle is jarred.

Preferably, the clamps can also be attached to the top of a triple clamp, which is a device with two deformable apertures that can be squeezed together with a bolt to hold the triple clamp to each of the forks going down on opposite sides of the wheel of a motorcycle and with a third aperture to accommodate the post about which the forks rotate in order to turn the front wheel of the motorcycles. But neither the attachment of the first clamp to the housing nor the attachment of the second clamp to the housing involves the triple clamp.

### BRIEF DESCRIPTION OF THE SEVERAL VIEWS OF THE DRAWING

FIG. 1 provides a lateral view from the rear of the Improved Fluidic Dampening Device.

FIG. 2 shows a front view of the Improved Fluidic Dampening Device.

FIG. 3 is a lateral view from the left side of the Improved Fluidic Dampening Device.

FIG. 4 is a lateral view from the right side of the Improved Fluidic Dampening Device.

FIG. 5 is a plan view from above the Improved Fluidic Dampening Device.

FIG. 6 shows the bottom of the Improved Fluidic Dampening Device.

FIG. 7 illustrates the Improved Fluidic Dampening Device attached to a triple clamp.

FIG. 8 is a lateral view from the left side of the Improved Fluidic Dampening Device showing the upper segment rotated upward from the lower segment of the first clamp.

FIG. 9 is a lateral view from the right side of the Improved Fluidic Dampening Device showing the upper segment rotated upward from the lower segment of the second clamp.

### DETAILED DESCRIPTION OF THE INVENTION

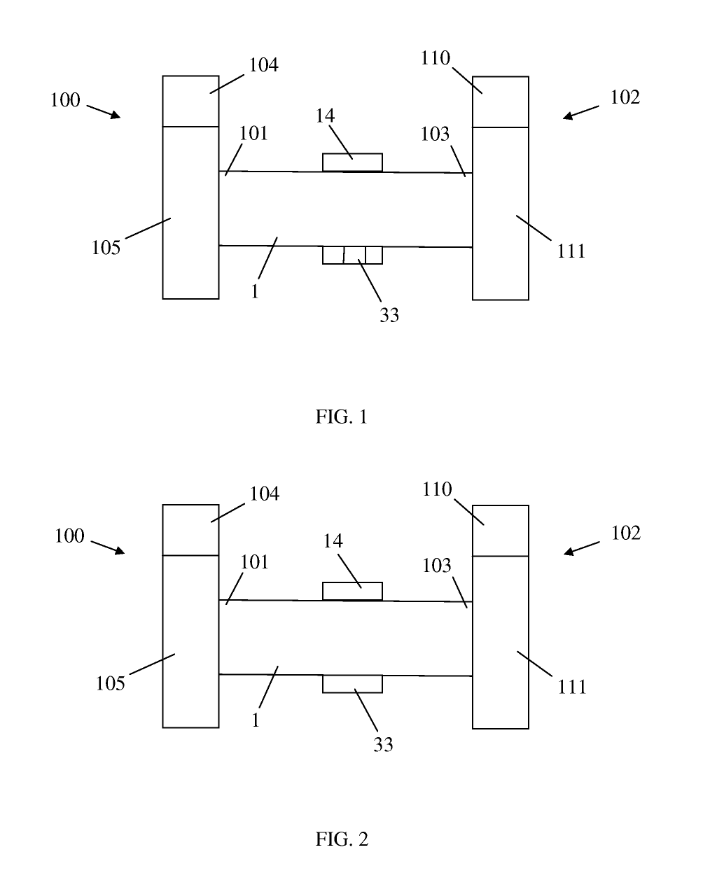

The present Improved Fluidic Dampening Device has, as seen in FIG. 1 and FIG. 2, a first clamp 100 attached to a housing 1 containing a bypass channel 9 having a first port 10 in a first side wall 3 and a second port 11 in the second side wall 4, near the first (left) side 101 of the housing 1. A wiper 7 is rotatably mounted between the side wall 3, 4.

More fully to describe an illustrative example of the type of dampening device supported by the clamp 100, U.S. patent application Ser. No. 10/166,498 is hereby incorporated by reference.

A second clamp 102 is, as seen in FIG. 1 and FIG. 2, attached to the housing 1 near the second (right) side 103 of the housing 1.

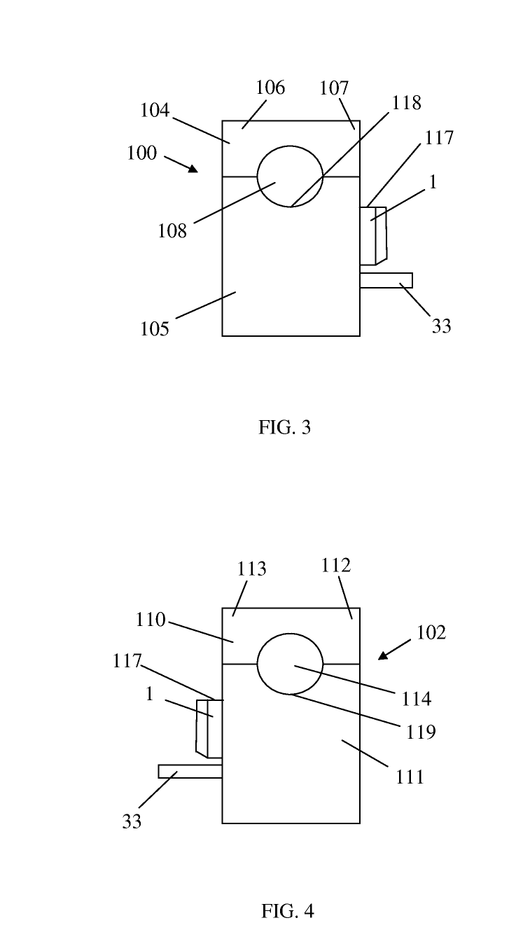

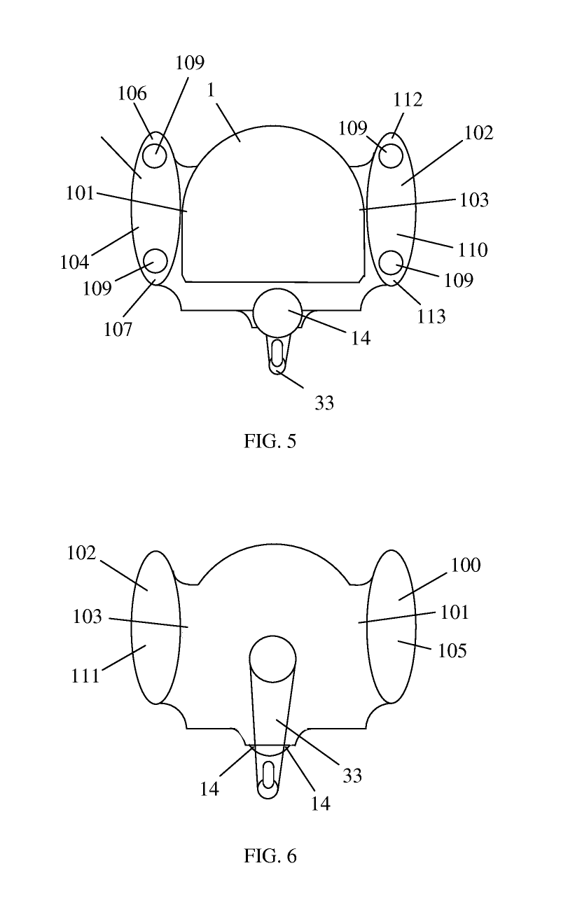

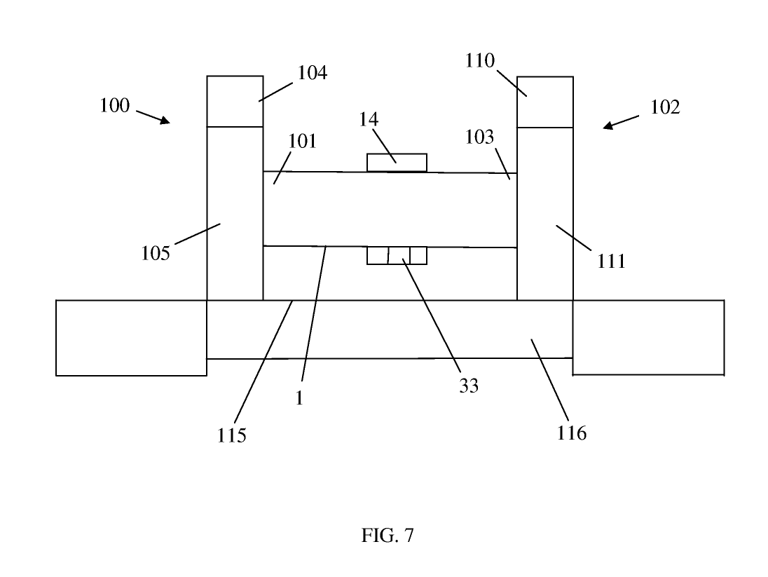

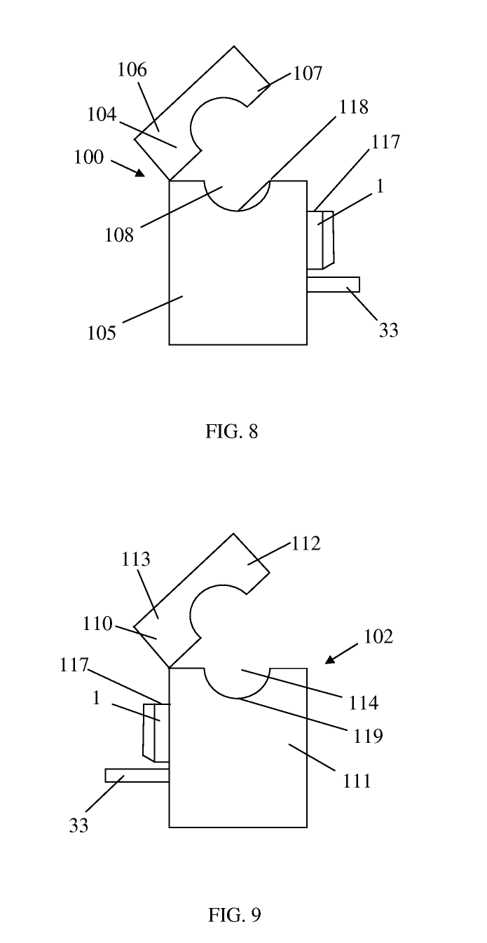

An upper segment 104 of the first clamp 100, seen in FIG. 3, is releasably attached to a lower segment 105 of the first clamp 100, although a first end 106 of the upper segment 104 can be rotatably attached to the lower segment 105 while a second end 107 of the upper segment 104 is releasably attached to the lower segment 105, so as to create an aperture 108 to accommodate handlebars. Releasable attachment is preferably accomplished with one or more screws 109.

Similarly, an upper segment 110 of the second clamp 102, seen in FIG. 4, is releasably attached to a lower segment 111 of the second clamp 102, although a first end 112 of the upper segment 110 can be rotatably attached to the lower segment 111 while a second end 113 of the upper segment 110 is releasably attached to the lower segment 111, so as to create an aperture 114 to accommodate handlebars.

The housing 1 is preferably so attached to the first clamp 100 and to the second clamp 102 that the uppermost portion 117 of the housing 1 is lower the lowermost portion 118 of the aperture 108 and the lowermost portion 119 of the aperture 114.

Preferably, the lower segments 105, 111 are releasably attached to the top 115 of a triple clamp 116, as illustrated in FIG. 7, for added support. But, as seen most clearly in FIGS. 1, 2, and 7, neither the attachment of the first clamp 100 to the housing 1 nor the attachment of the second clamp 102 to the housing 1 involves the triple clamp 116.

As used herein the term “preferable” or “preferably” means that a specified element or technique is more acceptable than another but not that such specified element or technique is a necessity.

I claim:

1. An improved fluidic dampening device of the type having a housing with an uppermost portion and containing a wiper and a channel for transferring fluid from a first side of the wiper to a second side of the wiper, wherein the improvement comprises:
a first clamp having an upper segment and a lower segment with the upper segment releasably connected to the lower segment so as to create an aperture with a lowermost portion, said first clamp being attached to the housing near a left side of the housing; and
a second clamp having an upper segment and a lower segment with the upper segment releasably connected to the lower segment so as to create an aperture with a lowermost portion, said second clamp being attached to the housing near a right side of the housing, wherein the attachment of said first clamp to the housing and the attachment of said second clamp to the housing is such that the uppermost portion of the housing is lower than the lowermost portion of the aperture in the first clamp and also lower than the lowermost portion of the aperture in the second clamp and also wherein the attachment of said first clamp to the housing does not involve a triple and the attachment of said second clamp to the housing does not involve a triple clamp.

2. The improved fluidic dampening device as recited in claim 1, further comprising:
a triple clamp having a top, with the top of the triple clamp being attached to the lower segment of said first clamp and to the lower segment of said second clamp.

3. An improved fluidic dampening device of the type having a housing with an uppermost portion and containing a wiper and a channel for transferring fluid from a first side of the wiper to a second side of the wiper, wherein the improvement comprises:
a first clamp having an upper segment and a lower segment with a first end of the upper segment rotatably connected to the lower segment and with a second end of the upper segment releasably connected to the lower segment so as to create an aperture with a lowermost portion, said first clamp being attached to the housing near a left side of the housing; and
a second clamp having an upper segment and a lower segment with a first end of the upper segment rotatably connected to the lower segment and with a second end of the upper segment releasably connected to the lower segment so as to create an aperture with a lowermost portion, said second clamp being attached to the housing near a right side of the housing, wherein the attachment of said first clamp to the housing and the attachment of said second clamp to the housing is such that the uppermost portion of the housing is lower than the lowermost portion of the aperture in the first clamp and also lower than the lowermost portion of the aperture in the second clamp and also wherein the attachment of said first clamp to the housing does not involve a triple and the attachment of said second clamp to the housing does not involve a triple clamp.

4. The improved fluidic dampening device as recited in claim 3, further comprising:
a triple clamp having a top, with the top of the triple clamp being attached to the lower segment of said first clamp and to the lower segment of said second clamp.
